(19) United States
(12) Patent Application Publication
(10) Pub. No.: US 2008/0099312 A1
(43) Pub. Date: May 1, 2008

(54) Modular belt with surface engraving

(75) Inventor: Marco Lucchi, Munchestein (CH)

Correspondence Address: HODGSON RUSS LLP;THE GUARANTY BUILDING, 140 PEARL STREET, SUITE 100, BUFFALO, NY, 14202-4040, US

(73) Assignee: Habasit AG

(21) Appl. No.: 11/586,124

(22) Filed: Oct. 25, 2006

(51) Int. Cl. B65G 15/30

(52) U.S. Cl. 198/844.1

(57) ABSTRACT

A method of marking modular plastic belts for identification or functional purposes including injection molding the plastic belt modules and then transferring the modules to laser marking station.

### FIELD OF THE INVENTION

This invention relates to conveyor belts and, more particularly, to modular plastic conveyor belts formed of rows of plastic belt modules pivotally interlinked by transverse pivot rods.

### BACKGROUND OF THE INVENTION

Because they do not corrode, are light weight, and are easy to clean, unlike metal conveyor belts, plastic conveyor belts are used widely, especially in conveying food products. Modular plastic conveyor belts are made up of molded plastic modular links, or belt modules, that can be arranged side by side in rows of selectable width. A series of spaced apart link ends extending from each side of the modules include aligned apertures to accommodate a pivot rod. The link ends along one end of a row of modules are interconnected with the link ends of an adjacent row. A pivot rod journaled in the aligned apertures of the side-by-side and end-to-end connected modules forms a hinge between adjacent rows. Rows of belt modules are then connected together to form an endless conveyor belt capable of articulating about a drive sprocket.

Modular belts and chains are typically made out of thermoplastic materials such as polypropylene, polyacetal, and polyethylene. Belts and chains are often marked with identification such as production number, production date, cavity identification, product name, supplier name, assembling/disassembling instruction, supplier logos or patent markings. The most common method for applying markings to a series of module is by mold engraving. The markings are typically applied to the rear of single modules. This method or technique for adding markings to the modules can only be applied when the mold is produced and is therefore practically irreversible. Accordingly, this method is relatively inflexible, and the method is not easy to adapt to the changing requirements of customers. It is possible to use replaceable mold inserts, but such inserts are expensive to produce and exchanging the inserts increases downtime for the mold and reduces productivity.

For additional flexibility with regard to marking the modules and specifically for customized marking of the belt surface it is common practice to use printing methods. Printing is, however, not abrasion resistant and therefore not long lasting.

Accordingly, there is a need for a method of marking modular belts and chains that does not suffer from the drawbacks of the methods described above.

### SUMMARY OF THE INVENTION

The present invention meets the above described need by providing a method for marking belt or chain modules that is flexible, abrasion resistant, long lasting, easy, and economical. It has been discovered that very specialized laser technology can be adapted to engrave the surface of plastic modules in such a way that abrasion resistant engravings are achieved. The process is highly flexible because the pattern to be engraved can be programmed on a computer that controls the engraving process. Due to the highly concentrated energy created by a laser, it is possible to engrave large patterns in a very short time period, e.g., ten seconds per square inch.

### BRIEF DESCRIPTION OF THE DRAWINGS

The invention is illustrated in the drawings in which like reference characters designate the same or similar parts throughout the figures of which:

FIGS. 1A to 1D show a diagrammatic section through an injection molding apparatus suitable for manufacturing a module for a modular conveyor belt according to the present invention;

FIG. 2 is a perspective view of a belt module of the present invention;

FIG. 3 is a top plan view of a belt module of the present invention; and,

FIG. 4 is a schematic diagram of the method of the present invention.

### DETAILED DESCRIPTION OF THE INVENTION

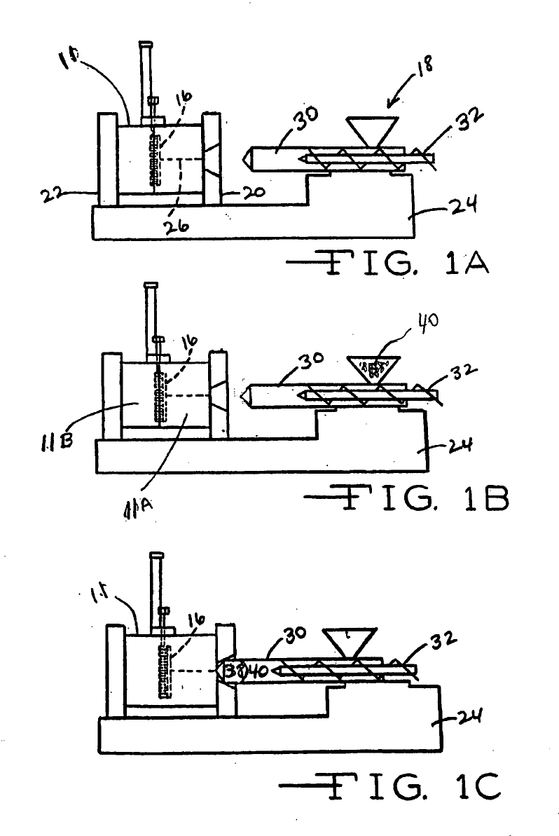

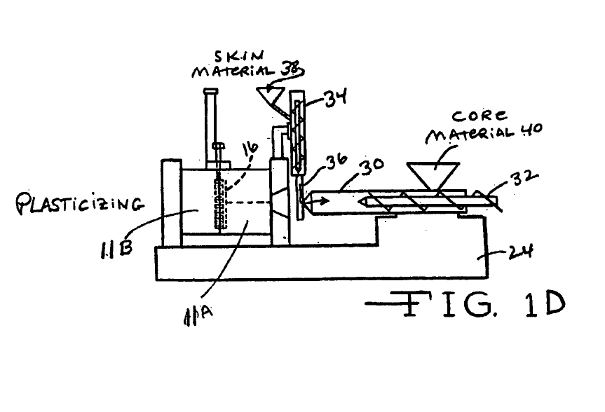

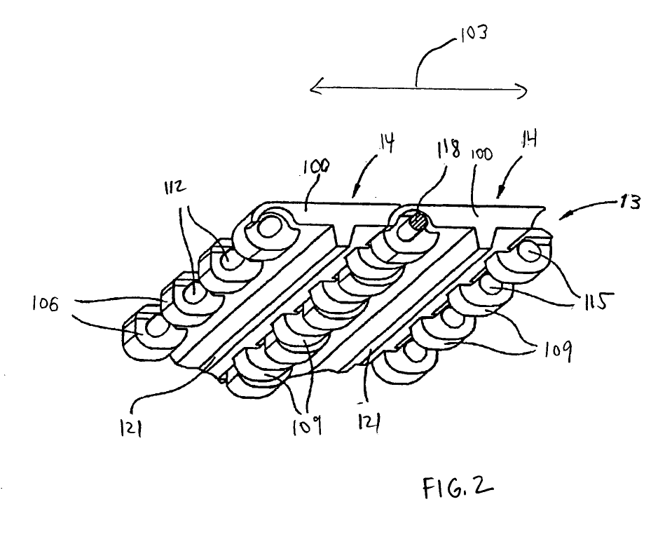

FIGS. 1A to 1C show a molding apparatus 10 including a mold 11 for making a module for a modular conveyor belt or chain according to the present invention. The mold 11 for producing the modules 10 includes first and second mating mold halves 11A, 11B (FIG. 1B) forming a mold cavity 16 for receiving a plastic melt from an injection unit 18. The mating mold halves 11A, 11B are mounted on a stationary platen 20 and a moving platen 22, respectively. The stationary platen 20, moving platen 22 and injection unit 18 are supported by a common base 24. The mold 11 includes a sprue channel 26 through the first mold half 11A which is in fluid flow communication with a nozzle 28 on the injection unit 18 when material is injected into mold cavity 16. The nozzle 28 is equipped with a shut-off valve (not shown) of the type that is well known in the art.

The injection unit 18 has a barrel 30 that includes a feed screw 32 of a configuration that is typical for injection molding. The feed screw 32 is controlled to reciprocate in the barrel 30 to plasticize and inject plastic into the mold 11. The injection unit 18 is equipped with means, such as a hydraulic cylinder (not shown) to move the unit 18 linearly toward and away from the mold 11. More specifically the injection unit 18 is moved against the mold 11 for injection, then is retracted away from the mold 11 and stationary platen 20.

A cycle of operation for the production of a module made by a molding method according to the present invention will now be described with respect to FIGS. 1A to 1C. The injection unit 18 is retracted to a rearward position (FIG. 1A), that provides clearance between the stationary platen 20 and the nozzle 28. The injection unit 18 plasticizes a sufficient quantity of the material 40 by rotating and retracting the feed screw 32 in a conventional manner so a full shot of melt is prepared.

The injection unit 18 moves forward to a position where the nozzle 28 communicates with the sprue channel 26 of the mold 11. As shown in FIG. 1C, the injection unit 18 then injects the polymeric material 40 into the mold 11 by advancing the feed screw 32 in a manner typical of the injection molding process. The injected material 40 fills the cavity 16 to create the belt module 14.

After cooling, the two mold halves open and the module 14 can be removed. As will be evident to those of ordinary skill in the art based on this disclosure, mold 16 may be shaped to form a product in the shape of a chain module, belt module, or other shape.

FIG. 1D shows an alternative embodiment with an auxiliary plasticizing unit 34 and hot runner manifold 36. The auxiliary plasticizing unit 34 is mounted adjacent the injection unit 18 on the stationary platen 20 and is capable of movement along a line perpendicular to the injection unit 18. Connected to the end of the auxiliary plasticizing unit 34 is a hot runner manifold 36. This orientation of the auxiliary unit 34 facilitates its positioning so that the hot runner manifold 36 is properly aligned in front of the injection unit 18 enabling direct connection with the nozzle 28. The auxiliary unit 34 is a non-reciprocating extruder; however, it could also be a second reciprocating screw injection unit, if desired. A cycle of operation for the production of a sandwich layer module having an outer skin made of a polymer including a color change additive activated by the laser marking system of the present invention will now be described with respect to FIG. 1D. The injection unit 18 is retracted to a rearward position that provides clearance between the stationary platen 20 and the nozzle 28. The auxiliary unit 34 is then moved downward so that the hot runner manifold 36 is disposed in front of the injection unit 18. The nozzle 28 of injection unit 18 then moves against the hot runner manifold 36 to establish a fluid tight connection between the injection unit 18 and the auxiliary unit 34. The auxiliary unit 34 is then activated to transfer plasticized skin material 38 via the hot runner manifold 36, through the nozzle 28 and into the end of the barrel 30 of the injection unit 18, causing the screw 32 to move backward within the barrel. As shown in FIG. 1B, transfer of the skin material 38 from the auxiliary unit 34 continues until a sufficient volume of polymeric material as defined by the module 14 geometry has been transferred. Next, the injection unit 18 plasticizes a quantity of the core material 40 and the combined shot of melt is molded as discussed above. In this manner, the color change additive would only be added to the outermost layer of the module 14 where the laser marking occurs.

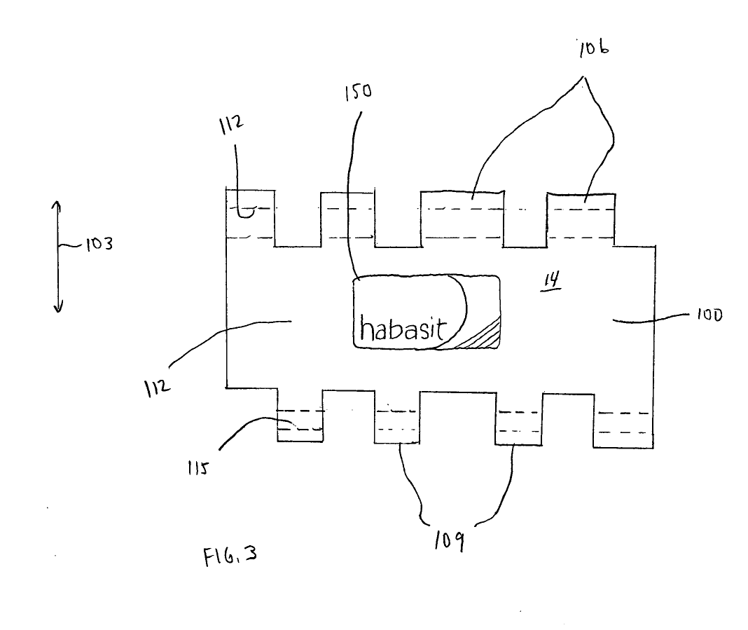

Turning to FIG. 2, a portion of a belt 13 that may be produced according to the present invention is shown. The belt 13 is formed from belt modules 14 having an intermediate section 100 that is disposed transverse to the direction of belt travel indicated by arrow 103. A first plurality of link ends 106 extend in a direction opposite from a second plurality of link ends 109. The link ends 106, 109 are offset such that the first link ends 106 on a first module are capable of intercalating with the second link ends 109 on an adjacent module. A longitudinal transverse rib 121 may extend from one side edge of the belt 13 to the other. The rib 121 provides strength to the module 14 and may engage with teeth on a sprocket (not shown) for driving the belt 13 as will be evident to those of ordinary skill in the art based on this disclosure. The first and second link ends 106, 109 have transverse pivot rod openings 112, 115 capable of aligning with pivot rod openings 112, 115 of adjacent modules 14 when the link ends 106, 109 are intercalated. With adjacent modules 14 positioned such that the link ends 106, 109 are intercalated and the transverse pivot rod openings 112, 115 are aligned, pivot rods 118 are inserted to form rows of belt modules attached end-to-end to form an endless belt 13 capable of articulating about a sprocket (not shown).

In addition to belt modules 14, the present invention may be used with belt modules that clip or hook together without pivot rods. An example of such belt modules is shown in U.S. Pat. No. 4,394,901, which is incorporated herein by reference.

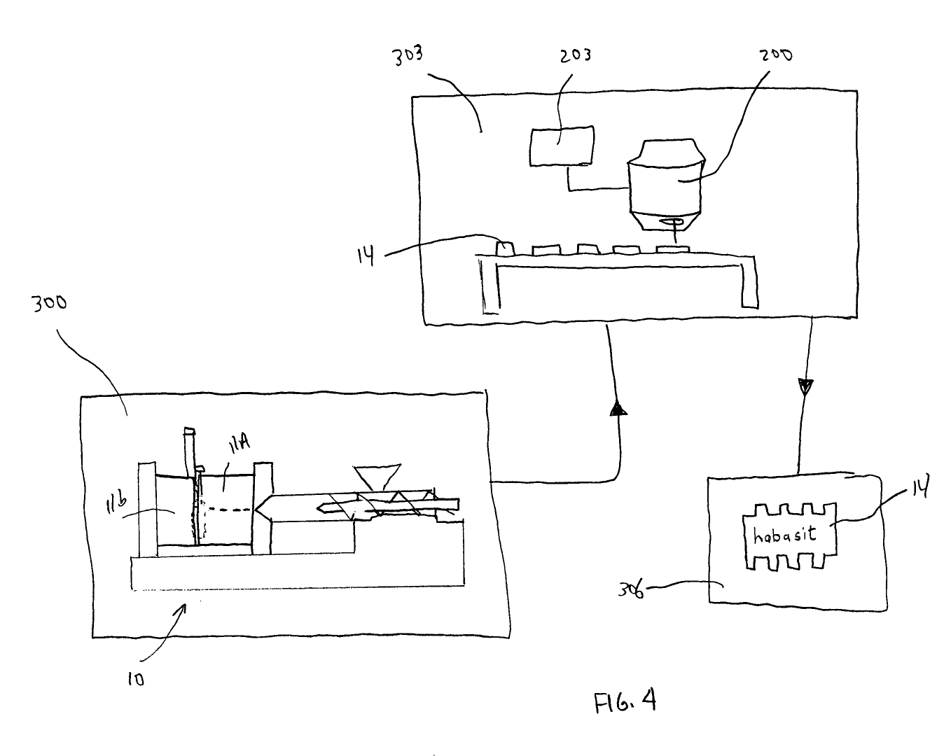

Turning to FIG. 3, the top surface 112 of module 14 may be provided with indicia 150 for product identification or advertising purposes. A carbon dioxide laser marking system 200 (FIG. 4) such as the LP 310-C laser marking system available from Matsushita may be used to engrave the surface of the plastic modules 14 in such a way that abrasion resistant engravings are achieved. The pattern to be engraved can be programmed on a computer 203 that controls the engraving process. Due to the highly concentrated energy of the laser marking system 200, it is possible to engrave large patterns in a very short time such as 10 seconds per square inch. Basically all thermoplastic materials used for belt modules 14 can be printed with this technology. The contours are sharp but mainly colorless, and the surface is sufficiently smooth to allow for efficient and easy cleaning. Colors can be realized by modifying the raw material 40 with suitable additives to obtain a color change during the melting procedure. In some special cases (e.g. PVC), a color change occurs without raw material additives. In addition, the modules 14 are suited under the FDA regulations, for use with belts 13 intended for conveying food products, because the material is only partially melted on the surface and no chemical change occurs.

In addition to indicia for identification and advertising purposes, it is also possible to realize functional structures on the surface. For example, engraved marks for measurement of the belt position, degree of mechanical wear, and the like are possible.

The laser technique of the present invention allows a positive as well as a negative font type depending on the application. A positive font is created by removing material from around the edges of the design so that the design is created in the element that is raised above the surrounding surface. In contrast a negative font is created by removing material to provide a design that is created in the cut out portion having a level that is lower than the surrounding surfaces. Many different designs including lines and geometric figures can be created and the designs can all be stored and transmitted to the laser marking system 200 via a computer 203.

The present invention provides many advantages including a lower investment over time compared to other marking systems, low cycle times because of the speed of the laser, high quality and precision engraving, ease of integration into the production line and high flexibility to accommodate changes on the fly.

Turning to FIG. 4, the method of the present invention involves the following steps. First, in step 300 a plastic belt module 14 is injection molded as described above in connection with FIGS. 1A-1C. The belt module 14 has an intermediate section 100 with a plurality of link ends 106, 109 extending from opposite sides in offset relation and having transverse pivot rod openings 112, 115 as described above in connection with FIG. 2. After the module 14 has cooled and is removed from the mold 11, the module 14 is transferred in step 303 to a laser marking station 200 where the design is applied to the module through application of a highly concentrated supply of energy from a carbon dioxide laser. The laser allows for engraving large patterns in a very short time, typically 10 seconds per square inch. The laser is controlled by the computer 203 such that numerous designs can be stored and retrieved for changes on-the-fly. The finished module 14 with indicia 150 is shown in step 306.

While the invention has been described in connection with certain embodiments, it is not intended to limit the scope of the invention to the particular forms set forth, but, on the contrary, it is intended to cover such alternatives, modifications, and equivalents as may be included within the spirit and scope of the invention as defined by the appended claims.

What is claimed is:

1. A method for producing a module, comprising:
providing a molding apparatus having an injection unit with a barrel housing a feed screw;
providing a mold with a cavity configured to the shape of the module being produced;
providing a polymeric material composition to the feed screw;
connecting the barrel with the mold and actuating the feed screw so that the polymeric material is injected into the mold;
removing the module from the mold; and,
marking the module with a predetermined design by means of a laser.

2. The method of claim 1, wherein the laser is a carbon dioxide type laser.

3. The method of claim 1, wherein the design comprises advertising indicia.

4. The method of claim 1, wherein the design comprises identification indicia.

5. The method of claim 1, wherein the design comprises functional indicia for the purpose of measuring belt position.

6. The method of claim 1, wherein the design comprises functional indicia for the purpose of measuring degree of mechanical wear of a belt surface.

7. The method of claim 1, wherein the module is constructed from materials consisting of the group selected from polypropylene, polyethylene, and polyacetal.

8. The method of claim 1, wherein the module comprises a belt module for an endless belt capable of articulating about a sprocket.

9. The method of claim 1, wherein the module comprises an intermediate portion having a first plurality of link ends and a second plurality of link ends extending therefrom.

10. The method of claim 9, wherein the first plurality of link ends and the second plurality of link ends are offset such that the second plurality of link ends are capable of intercalating with the first plurality of link ends of an adjacent like module.

11. A modular belt system, comprising:
a modular belt having a plurality of belt modules, each belt module having an intermediate section with a first plurality of link ends extending in a first direction therefrom and a second plurality of link ends extending in a second direction opposite the first direction, the first and second plurality of link ends having transverse openings defined therein, the transverse openings on the first and second link ends capable of aligning when the first link ends are intercalated with the second link ends of an adjacent module, the belt modules capable of being pivotally connected in rows by a pivot rod, at least one module having a laser marked design disposed thereon; and,
at least one pivot rod disposed through the aligned transverse pivot rod openings in adjacent belt modules.

12. The belt system of claim 11, wherein the laser is a carbon dioxide type laser.

13. The belt system of claim 11, wherein the design comprises advertising indicia.

14. The belt system of claim 11, wherein the design comprises identification indicia.

15. The belt system of claim 11, wherein the design comprises functional indicia for the purpose of measuring belt position.

16. The belt system of claim 11, wherein the design comprises functional indicia for the purpose of measuring degree of mechanical wear of a belt surface.

17. The belt system of claim 11, wherein the module is constructed from materials consisting of the group selected from polypropylene, polyethylene, and polyacetal.

18. A method for producing a module, comprising:
providing a molding apparatus having a main injection unit with a barrel housing a feed screw, and an auxiliary plasticizing unit;
providing a mold with a cavity configured to the shape of the module being produced;
transferring a first quantity of a first polymeric material from the auxiliary plasticizing unit into the barrel of the main injection unit, the first polymeric material having a composition including additives capable of producing a color change when exposed to a laser;
transferring a second quantity of a second polymeric material from the main injection unit into the barrel so that the barrel contains both the first polymeric material and the second polymeric material in discrete shots loaded into the barrel;
connecting the barrel with the mold and actuating the feed screw so that the first polymeric material is first injected into the mold to form a skin for the module followed by the second polymeric material injected into the mold to form a core for the module; and,
removing the module from the mold.

19. The method of claim 18, wherein the module is constructed from materials consisting of the group selected from polypropylene, polyethylene, and polyacetal.

20. The method of claim 18, further comprising marking the module with a predetermined design by means of a laser.
